(19) United States
(12) Patent Application Publication
(10) Pub. No.: US 2007/0193082 A1
(43) Pub. Date: Aug. 23, 2007

(54) Substantially circumferentially extending printed advertising piece for use with consumer beverage containers

(75) Inventors: Jesse D. Crum, Fort Scott, KS (US); William R. Russell, Pittsburg, KS (US)

Correspondence Address: Michael C. Maier, Esq.;Ward Kraft, Inc., P.O. Box 938, Fort Scott, KS, 66701, US

(73) Assignee: Ward/Kraft

(21) Appl. No.: 11/348,824

(22) Filed: Feb. 7, 2006

(51) Int. Cl. G09F 3/00

(52) U.S. Cl. 40/324

(57) ABSTRACT

The present invention relates to a printed business communication having a first printed surface on a first substrate and a second undulating portion affixed to one side of the substrate opposite that of the printing. At least a portion of the undulating piece can be printed with promotional, advertising, marketing or other informational imaging to compliment the message printed on the first substrate. The intermediate formed from the combined materials can then be used in connection with creating a cylindrical configuration suitable for use in wrapping a consumer beverage container.

### CROSS-REFERENCES TO RELATED APPLICATIONS

None.

### FIELD OF THE INVENTION

The present invention is directed to a high resolution marketing piece that is intended to serve as a consumer package wrap, such as for consumer beverage containers and the like. The piece is provided in a two piece arrangement that is produced substantially in situ which includes a first substantially planar material that is printed on at least one side with high quality graphics and preferably at a resolution of greater than about 150 lines per inch. A second material is converted from a substantially planar web to a fluted configuration and is at least intermittently bonded to the first material to form an intermediate assembly that may then be shaped to the particular configuration desired by the manufacturer or end user.

### BACKGROUND OF THE INVENTION

There are currently a plethora of business communication constructions, marketing and advertising pieces and other items that are available in the market today for communicating products and services with an intended audience. Yet with this inordinately large selection of offerings and permutations, there remains a continuing need to develop new products due to changes in technology, societal trends, diversification of marketing, packaging and advertising campaigns and new information handling needs of businesses and consumers alike.

However, while printed products, such as pieces and other assemblies that are intended to be used in business communications, including advertising and marketing collateral, can be delivered in a wide variety of formats, constructions and configurations, the manufacturing of such diversified products may simply be unattainable by most producers of such products, particularly smaller sized manufacturers, or may simply be too expensive to justify expenditures for equipment that may be able to create such products.

Typically, one of the most significant limiting factors for a manufacturer in being able to produce a particular construction or expand product capabilities is the available equipment the manufacturer has on hand or which may be available on the market to generate such printed pieces. Such forms handling machinery and other printing apparatus even if available for acquisition can be quite expensive and in addition the equipment may require some customization before the equipment can be integrated into a particular manufacturing processes. Thus, egress into new product categories may simply not be possible due to cost constraints.

Equipment may be further limited by the type of stocks or substrates that can be effectively handled or processed by such presses thereby further limiting the potential output of the types of products from manufacturers. For example, board or tag stocks are exemplary materials that due to the thickness of the substrate cannot be handled by most types of equipment and thus cannot be printed upon by such conventional printing technologies as flexographic.

Flexography is one exemplary conventional technology that is commonly used today for the printing of decorative items, packaging films and the like because of the ability of the technology to print substrates in multiple colors. However, flexography is one exemplary technology that suffers from the foregoing drawbacks, of being able to handle thicker substrates and add significant variability to the materials being produced.

Flexographic technology is commonly used today in the rendering of film packaging, marketing communications and normally will utilize a series of plates and one or more stations, containing inks; to apply colored images to the web as the web traverses the press. Through improvements in ink qualities and other modifications and enhancements in the technology, the image quality in flexographic presses and resulting products has improved to about 150 lines per inch. In addition, flexographic printing presses are also limited by the thickness of the substrates that can be effectively handled and processed by the equipment.

Typically, for a point of reference, screens that have rulings of about 60 to 100 lines per inch are normally used to make halftone printed images for newspapers. Screens with about 120 to 150 lines per inch are commonly used today to produce images for magazines and commercial printing. Such screens are regularly produced by electronic dot generation.

Electronic dot generation is normally performed by computers that use unique screening algorithms in cooperation with electronic scanners and image setters to produce halftone images that are to be subsequently used to render an image. The pixels of digitized images are first assembled into dots that are then used to form shapes, sizes, rulings, etc. which create the ultimate image produced on the substrate.

While use of such conventional technology such as flexography is desirable in the printing of films and other materials due to the economies that can be achieved when compared with other types of printing processes, such as lithography, there are a number of drawbacks in utilizing this process for certain applications. Initially, the quality is limited, despite improvements in the technology to about 150 lines per inch. This can make some complicated graphics appear “grainy”. Other images such as those that use flesh tones or deep or rich colors, may look faded or “washed out”. The effects of this level of image resolution can detract from the product appearance which may diminish the value of the technology and the products produced. With increasing sophistication of consumers, as well as technology and expectations from each, such effects may be undesirable to potential end users.

The market for printed communication material is also changing and becoming more sophisticated. Such conventional business forms manufacturers have normally produced product runs that range in the hundreds of thousands to millions or even tens of millions of pieces for a single order. These single orders may be produced for example in connection with a multiple part medical form product, insurance form or the like. As such, the equipment that is used to produce product at these levels or quantities is then set up to handle only large manufacturing runs. The apparatus used in this type of fulfillment will normally only operate efficiently in this higher range of production quantities and often cannot be reconfigured as the apparatus has been constructed in such a specific manner so as to be able to optimize production efficiencies of these larger runs. Thus, even if a manufacturer wished to pursue smaller runs, particular niche markets opportunities, specialty configurations or orders sizes, the manufacturer is faced with the dilemma of making new capital expenditures to purchase equipment that specializes in this type of application. This along with the possibility of having to retrain existing personnel or hire and train new employees to generate this type of production activity places additional constraints on the decision making process.

Traditional manufacturers of business communications, such as business forms and labels, may also be limited in the type of jobs that a manufacturer will accept and have typically not pursued more lucrative areas such as consumer goods packaging due to the uniqueness of the equipment that may be used in producing such products. These additional factors may include the size of the job, or more particularly the order quantity or value of the order. That is, due to cost factors, a customer will not place an order with a manufacturer for a small to medium quantity of specialty pieces as the set up or make ready of the job makes the order cost prohibitive, even assuming that the manufacturer would accept the order if a particular price could be obtained to justify production.

A still further drawback of trying to migrate to smaller or specialized customer applications relates to quality of the pieces that need to be generated. With the focus of the market slowly shifting to smaller runs, the end user is now demanding a greater image quality than that typically associated with conventionally printed products. It is believed that one of the reasons for such far reaching changes is that budgets for marketing and business communications have been cut back in recent years and as such, end users want more from each piece that is produced rather than relying on the quantity of pieces to generate the desired result. In addition, marketers want to make a greater impact at every turn in the retail chain to try and maximize the chances for purchases of a particular product being offered. Providing opportunities to extend or enhance marketing trends has been commonly welcomed by such firms and such priorities or demands often drive manufacturers to seek out other opportunities.

With the change in focus to quality as opposed to quantity there are a number of products that to date are still out of reach of conventional manufacturers in that certain materials are simply to thick or unwieldy to be able to be handled by printing equipment and forms processing apparatus.

Conventional packaging does little in the way of marketing or encouraging point of sale type activity to entice a consumer to purchase one product over another or to acquire additional complimentary products, upgrades or other services that may be of interest to the consumer.

In this age of brand marketing, and positioning of products in the consumer focus, so much of the effort associated with advertising and marketing to the consumer through conventional media outlets (e.g. television, radio, magazines, etc.) is then lost, as the package does not necessarily complete the image or finish the delivery of the message that the manufacturer of the consumer good wishes to convey to prospective customers.

This situation of plain or bland packaging is further exacerbated in connection with large marketing or promotional initiatives such as may occur around particular holiday seasons, or with the release of long awaited software or hardware, publications or new product launches. Marketing and/or advertising agencies spend significant sums in order to communicate to the public the launch or release of a product or service. The effect of this large effort can be mitigated due to the relatively uneventful packaging in which the product is delivered to the ultimate consumer.

Paperboard containers have been previously printed, such as with what may be found in connection with consumer food packages and such printing is commonly done in very few colors and at a relatively low resolution.

The ability to produce corrugated type materials with high quality printing has heretofore been relatively unattainable due largely to the thickness of the material and the inability of high quality resolution printing presses to be able to handle such materials. As such, corrugated packaging materials have simply had little effect in communicating marketing and business messages to consumers and potential customers.

Corrugated packaging materials have heretofore been used in connection with beverage packages and having consisted of a stripped down corrugated assembly in which a fluted material is provided with a smooth outer covering. The outer covering may be printed and as with other corrugated packaging, the imaging has largely been limited in the number of colors that can be rendered in connection with an order and resolution of the imaging that is produced on the surface of the material. In addition, the interior surface of such assemblies has been largely ignored as a space for further communication of a message to a consumer of the products.

Thus, what is needed therefore is a product and process by which a corrugated type of consumer packaging material can be produced relatively in situ and thereby allows high quality imaging equipment to produce packaging materials that can effectively display and deliver advertising and marketing messages.

### BRIEF SUMMARY OF THE INVENTION

The embodiments of the present invention described below are not intended to be exhaustive or to limit the invention to the precise forms disclosed in the following detailed description. Rather, the embodiments are chosen and described so that others skilled in the art may appreciate and understand the principles and practices of the present invention.

Surprisingly, it has been discovered that there does not exist today a printed business or marketing communication piece that can be used to extend the marketing and advertising message of a retail outlet when affixed to a consumer beverage package. The intermediate assembly of the present invention can be formed from two substantially similar materials, one of which is printed and the second of which is pressed into a regularly occurring undulating pattern and which can have printing appearing on portions of the undulations. The intermediate is then formed to a substantially circumferentially extending component that is then applied to the exterior of a consumer beverage package. The piece may be further provided with areas of repositionable adhesive that can be used to hold or retain the piece in position with the beverage container.

In one exemplary embodiment of the presently described invention, a printed business communication piece for holding cylindrical consumer products is described and includes a first substantially planar substrate that has first and second faces, first and second transversely extending edges and first and second longitudinally extending sides. The first face is printed at a resolution of greater than 150 lines per inch.

A second substrate is provided that has first and second faces, first and second transversely extending edges and first and second longitudinally extending sides. The second substrate has a regularly undulating pattern and the second substrate first face is at least intermittently bonded to the first substrate second face such that the first and second transversely extending edges of each of the first and second substrates are substantially aligned with one another.

The first and second substrate together form an assembly for use in wrapping a consumer beverage container and the second substrate second face is provided with imaging on at least a portion of the undulating pattern.

In a further exemplary embodiment produced in accordance with the presently described invention consumer beverage package is provided and includes a consumer beverage container which has imaging provided on an outer surface. The consumer beverage container has a substantially circumferentially extending outer surface.

A first substantially planar substrate that has first and second faces, first and second transversely extending edges and first and second longitudinally extending sides, is included with the presently described embodiment. The first face is printed at a resolution of greater than 150 lines per inch and the imaging includes features matching features on the beverage container.

A second substrate is used in connection with the presently described embodiment and has first and second faces, first and second transversely extending edges and first and second longitudinally extending sides. The second substrate has a regularly undulating pattern pressed into the substrate and the second substrate first face is at least intermittently bonded to the first substrate second face such that the first and second transversely extending edges of each of the first and second substrates are substantially aligned with one another.

The first and second substrates form a substantially circumferentially extending assembly which conforms to at least a portion of the surface of the consumer beverage container and in which the undulating portion is against the outer surface of the consumer beverage container.

In a still further exemplary embodiment of the presently described invention, a method of producing printed business communication pieces for holding cylindrical consumer products substantially in situ is described and includes the steps of initially providing a first substantially planar substrate having first and second faces, first and second transversely extending edges and first and second longitudinally extending sides. Then, the first face of the first substrate is printed at a resolution of greater than 150 lines per inch.

A second substrate is provided and has first and second faces, first and second transversely extending edges and first and second longitudinally extending sides. The second face of the second substrate is printed at regularly spaced intervals. Next, a series of regular undulations is created in the second substrate with each upwardly extending undulation having a printed surface.

Then, at least intermittently, the second substrate is adhered first face to the first substrate second face such that the first and second transversely extending edges of each of the first and second substrates are substantially aligned with one another to form an intermediate assembly.

The foregoing method embodiment may also include additional steps such as forming an intermediate assembly which can then be used in connection with a consumer beverage package. Die cutting the intermediate to create additional shaped configurations or alternatively, to remove waste or excess material.

The advancing and providing of the first and second substrates as well as the printing of the substrates may occur substantially simultaneously. In addition, the first face of the first substrate may be provided with a tipped or blown on element which is readily removable and which may contain additional matching indicia to that provided on the substrate.

The second face of the second substrate may be provided with a pattern of repositionable adhesive to aid in holding the assembly to the consumer beverage container

These and other objects of the invention will become clear from an inspection of the detailed description of the invention and from the appended claims.

### BRIEF DESCRIPTION OF THE DRAWINGS

These, as well as other objects and advantages of this invention, will be more completely understood and appreciated by referring to the following more detailed description of the presently preferred exemplary embodiments of the invention in conjunction with the accompanying drawings, of which:

FIG. 1 depicts the business communication piece prepared in connection with the present invention affixed to a consumer beverage container;

FIG. 2 shows a cross sectional view of the business communication assembly prepared in accordance with the present invention and showing the various imaging patterns that can be produced on the assembly;

FIG. 3 illustrates the printing on the second face of the second substrate prior to undulations being formed in the second substrate;

FIG. 4 provides a further illustration of the printing on the second face of the second substrate with the undulations provided as well as the pattern of repositionable adhesive; and

FIG. 5 depicts a block diagram of the exemplary steps taken in connection with preparing the business communication of the present invention.

### DETAILED DESCRIPTION OF THE INVENTION

The present invention is now illustrated in greater detail by way of the following detailed description which represents the best presently known mode of carrying out the invention. However, it should be understood that this description is not to be used to limit the present invention, but rather, is provided for the purpose of illustrating the general features of the invention.

The instant specification sets forth a unique concept by which corrugated type packaging material can be prepared using commercial quality imaging and business forms type processing equipment in a manner so as to enhance consumer goods packaging in order to provide a more attractive marketing package for the customer of a particular product or service.

The printing or imaging that is applied to the sheets of material that form the outer surface of the package when formed will preferably have complimentary imaging to the consumer good, such as a beverage that is contained within the package. The imaging or printing can be used to convey information about other related or complimentary products, marketing, advertising or promotional information relating to the products, or other members of the product families as well as product announcements, information and the like. In addition, the printing or imaging can be used to create gift packages such as by printing colorful patterns or designs, similar to those found on wrapping paper as well as names and gift giving occasions such as birthdays and holidays. Thus, the invention described in the instant specification can be used to create a personalized package out of relatively bland packaging type material.

By preparing packaging material as provided in connection with the present invention, commercial quality printing and imaging equipment can be used to prepare wrapping assemblies for consumer beverage containers.

There are a number of terms used throughout the instant specification which are discussed below in cursory terms. The definitions provided are not intended to limit the scope of the invention and the information is provided for illustrative purposes.

As used herein the term “business communication” is used to refer to a printed or imaged piece, document or substrate that when used with the laminate as described in the present invention will convey a particular message, image or provide information about a particular product or service that is available from the provider of such pieces or documents. Business communications, documents or pieces can include advertising, sales and marketing collateral and such other items used to convey information, and in connection with the present invention.

The term “intermediate” as used herein refers to a product that undergoes one or more processing steps prior to the intermediate reaching a final condition, that of being ready for end use or application. The additional processing steps may include printing, imaging, folding, forming, sealing, separating, cutting, perforating, scoring, adhering, laminating and the like. Typically, a product such as with the present invention is provided in an intermediate condition so that a user or downstream manufacturing point can add or manipulate the intermediate to create the final or desired end product, such as creating a finished carton or package. Thus, in accordance with the present invention, the intermediate segment for example, could be subject to die cutting or additional printing, such as through ink jetting, over laminating, coating or embossment, and then applied to a blank for further processing, such as to create a package, carton or the like.

The term “personalized information” refers to information that is printed or imaged onto a substrate or document which is generally variable or unique and which may change from laminate to laminate so as to create a customized message or communication for each recipient. Examples of personalized information may include names, addresses, descriptions, plans, coding, numbering, promotional text, recipes based on contents, etc. that may have been acquired from the intended recipient through surveys, questionnaires or answers given to various inquiries generated in response to a request for goods or services.

The term “static or fixed” information refers to printed or imaged information that generally does not change from laminate to laminate and may include a general description or body of information about particular products, services, places, etc. that may be of interest to the intended recipient and represents a standard message that the manufacturing or supplier wishes to convey to an end user or customer of the offering.

Examples of image generating or high quality printing devices that are suitable for use in practicing the invention include high resolution imaging devices such as Indigo®, available from Hewlett Packard of Palo Alto, Calif. or Karat available from KBA of Williston, Vt. Ideally, the present invention seeks to provide images on a substrate that has a resolution quality of about 150 or more lines per inch and preferably more than 300 lines per inch, which is approximately equal to about 2500 to 3500 dots per inch (“DPI”) in order to create a high quality image that is intended to be aesthetically appealing to the consumer. Other imaging equipment may of course be used depending on the sheet or web size that the equipment can efficiently handle.

The system can be used to produce highly personalized textual information in addition to generating high quality, high resolution graphical images. Such textual information may include details relating to the graphics to be generated.

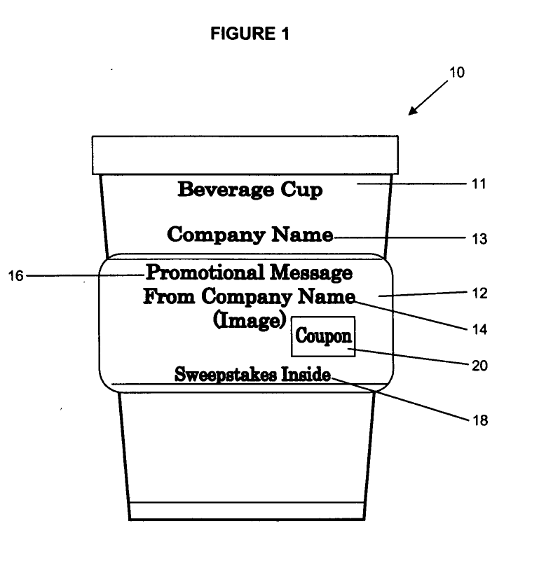

Reference is now directed to FIG. 1 of the present invention which illustrates a consumer beverage container generally designated by reference numeral 10. The container 10 is generally cylindrical in shape and has the business communication intermediate 12 wrapped around a portion of the outer surface 11 of the container 10. The container 10 is provided with imaging 13 representing for example the company name or other imaging that may be applied to the container 10. Matching indicia 14 is printed on the business communication assembly 12 as is promotional indicia 16 and other information such as sweepstakes information at 18. In addition, the business communication intermediate 12 is shown with a blown on or tipped on removable element 20 which may be a coupon or the like and which may also be provided with indicia that matches the printing that has been provided on the container 10 and business communication piece 12.

It should be understood that both the first and second substrates used in the construction of the present invention will each have first and second longitudinally extending sides, first and second transversely extending edges and first and second faces.

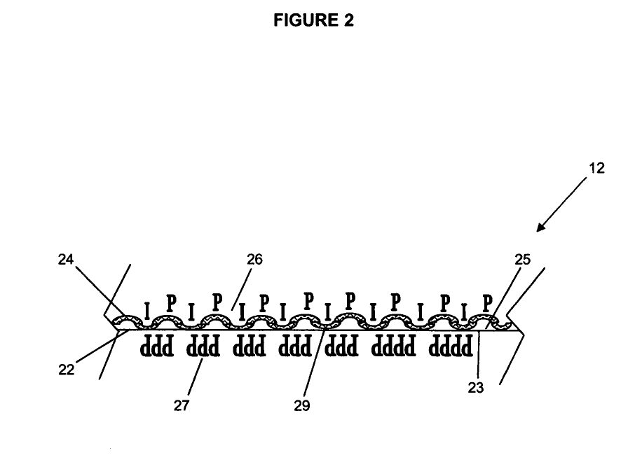

Attention is now directed to FIG. 2 of the presently described embodiments which shows a cross sectional view of the business communication 12 depicted in FIG. 1. The business communication assembly, generally referenced by numeral 12 includes a first substantially planar substrate 22 as well as second substrate constructed preferably of substantially similar material 24 to which an undulating pattern 26 has been applied. The pattern may be created by any suitable means such as by engaging the substrate between a pair of toothed rollers that intermesh with one another such that a series of peaks and valleys are formed. The substrate 22 has first and second faces 23 and 25, respectively. The first face 23 has been provided with printing or imaging 27 which is depicted by a series of repeating characters “PPP.”

The second substrate 24 as shown in FIG. 2 is provided with a series of peaks and valleys to which printing has been applied. The two types of printing are represented by the character “P” that may rest on the top of each undulation and “I” which may be in each valley of the undulation. The second substrate 24 is at least intermittently adhered to the first substrate where each of the valleys 29 contacts the first substrate 22.

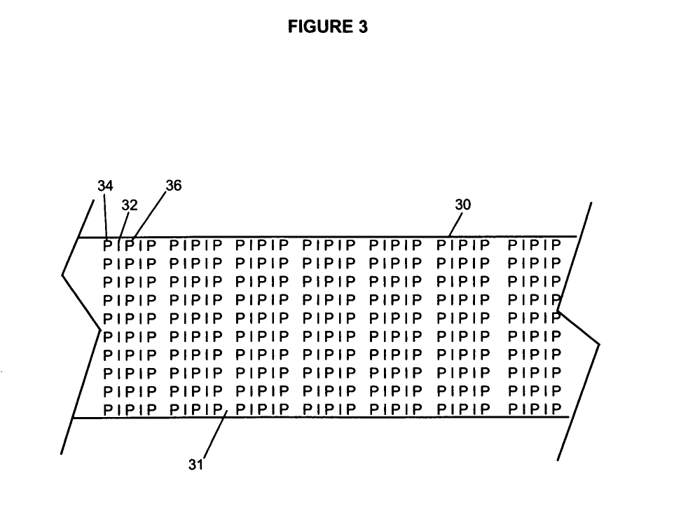

FIG. 3 shows the second substrate 30 second face 31 and the printing that has been applied. The substrate 30 is in a substantially planar arrangement so that the printing on the face of the substrate can be readily accomplished. The printing 34 and 32, shown as separate, distinct lines for illustration purposes occurs at regularly spaced intervals such that one type of printing, represented for example by “P” (reference numerals 34 and 36) will appear at the top of the undulations, and the second type of printing “I” will appear in the valley of the undulations, once the undulations are formed in the substrate. The spacing of the printing 34 and 36 will be directly proportional to the size or width of the undulations provided in the substrate. For example, if the surface of each undulation is 1/16 of an inch and each rise is approximately 1/32 of an inch (two rises per undulation) then each row of printing represented by “P” will be approximately ⅛ of an inch apart. Likewise, the second pattern of printing 32 will also be spaced an equal distance apart from successive lines as in a preferred embodiment, the size of the undulations is regular. By providing printing in this fashion or manner then, the undulations can be used to convey a particular message or provide promotional material or marketing information.

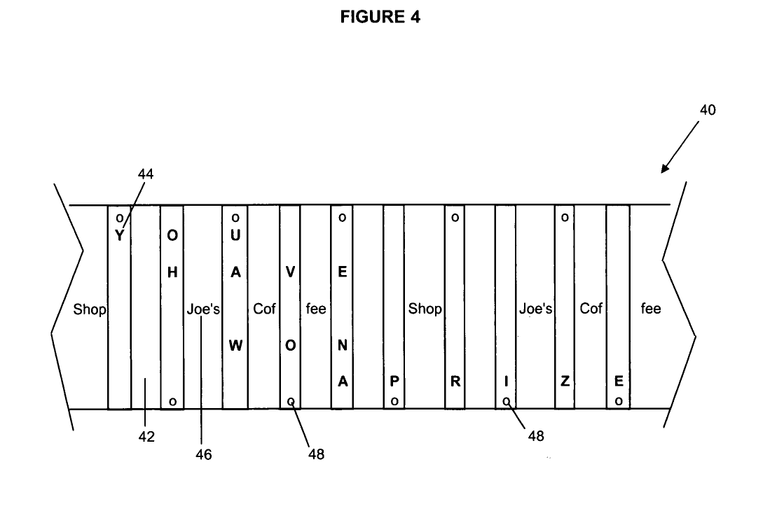

Turning now to FIG. 4 of the presently described embodiment, and again the second substrate 40 is shown with the second face 42 being visible. The first pattern of printing 44 appears on the surface of the undulations and is used to spell out a message, such as “YOU HAVE WON A PRIZE” which could be a variable or personalized message, which would have particular relevance in a sweepstakes promotion. For example, the first printing 44 could be used for individual prize awards, discount or coupon information for future purposes and the like. While the imaging 44 has been shown as occurring at different portions of the substrate, it should be understood that the printing may occur at all the same level.

The second pattern of printing 46 is also used to convey a message. In this example, it is a fixed or static message “JOE'S COFFEE SHOP” that repeats in the valley of the undulations. When the second face of the second substrate is viewed directly, that is, the line of sight is perpendicular to the surface of the substrate, both messages will be clearly visible. However, when the substrate is viewed at other than substantially at a right angle the message in the valley of the undulations will be hidden, thus providing in essence a lenticular printing type affect.

FIG. 4 is also used to illustrate the application of a pattern of repositionable adhesive dots or spots 48. Occasionally, when such business communication pieces are applied to the exterior surface of a beverage container, the piece may have a tendency to slip off. By providing spots of repositionable adhesive, the spots will aid in holding the piece to the container. Where such pieces are stacked or in a folded configuration, the repositionable adhesive will enable individual pieces to be separated from one another without significant sticking. The spots 48 may be placed at various positions throughout the surface of the substrate and may occur in a regular pattern placement or alternatively, may be placed randomly.

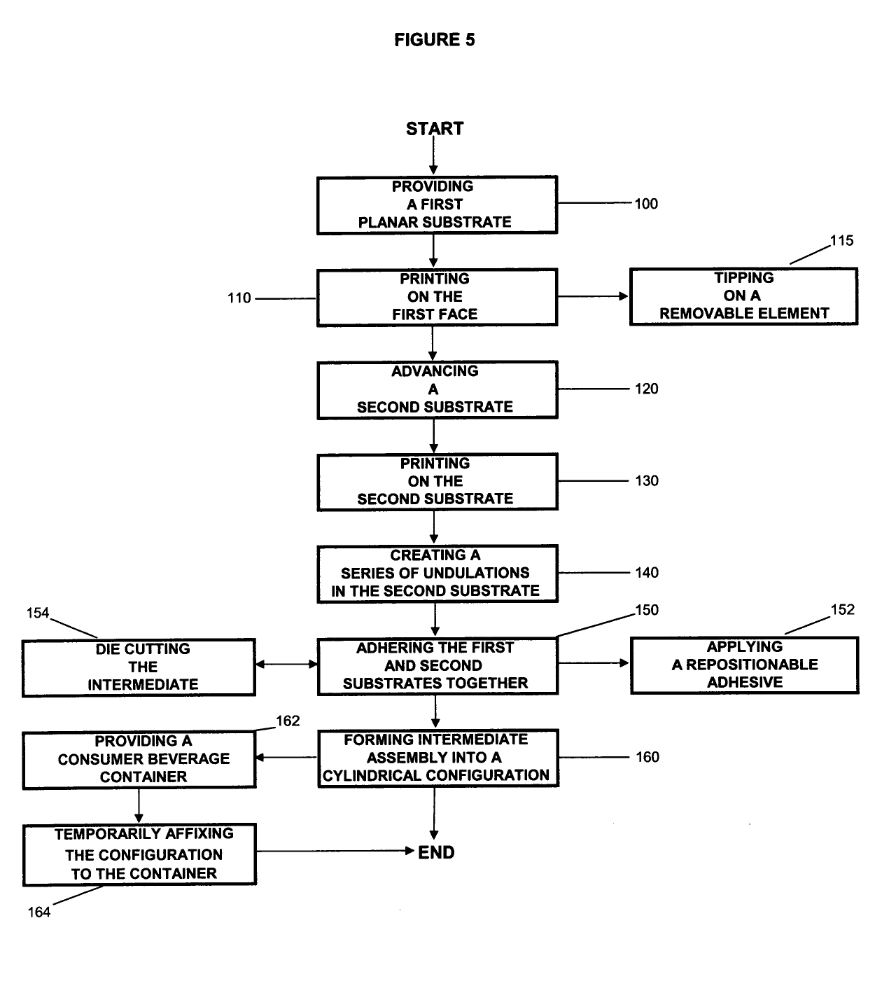

Attention is now directed to FIG. 5 which provides a block diagram showing exemplary steps used in practicing the present invention. The process is started by providing a first substrate at step 100, which will preferably be a cellulosic material such as paperboard or unbleached paper. The substrate is provided to the printing device in a substantially planar configuration so that it can be easily fed through the printing device. The substrate may be provided in a sheet or continuous web configuration depending on the manufacturing equipment being used at the production site.

The substrate is printed preferably on the first face of the substrate at step 110. Preferably, the imaging or printing is performed at a resolution of greater than about 150 lines per inch and still more preferably at greater than about 250 lines per inch and still more preferably at greater than about 300 lines per inch. After the substrate is printed at step 110, a removable element may be tipped or blown on at step 115. The removable element may include labels, prime labels, coupons, tags, tickets or any other piece that may be desirable. The removable element may be held by an adhesive, such as a repositionable or removable adhesive or other frangible coating which will allow for ready separation of the element from the surface of the substrate.

Next, a second substrate is advanced at step 120. The second substrate is similar to the first substrate and is substantially the same width as the first substrate. Typically, the second substrate will be supplied from a larger source (more linear feet) as the second substrate will be subjected to an undulating operation. The second substrate is printed at step 130 as indicated above, that is, the printing is conducted at regular spaced intervals so that the message can be read. The printing and undulating steps will be preferably controlled by a computer and will be timed so as to ensure proper placement of the images and the undulations.

The printing on the second substrate will likely be variable or personalized, such as in connection with a sweepstakes or other promotional or advertising activity. In addition, where prizes are to be awarded, the printing of prize information will be randomized in order to achieve the objectives of the promotional activity.

A series of regularly occurring undulations are created in the second substrate at step 140. The undulations are achieved by passing the substrate through a pair of toothed, intermeshing rollers that will impart waves into the surface of the substrate. The movement of the first and second substrates as well as the printing can be accomplished substantially simultaneously. Once the undulations have been imparted to the second substrate, the second substrate first face is adhered to the first substrate second face at step 150. The substrates are adhered to one another at the valleys of the undulations as previously described in connection with FIG. 2.

In addition to printing on the second substrate at step 130, a pattern of repositionable adhesive may be applied at step 152 to aid in holding the business communication piece to the consumer beverage container. In addition, after the first and second substrates are adhered to one another at step 150, the substrates may be die cute at step 154 to create any particular shaped configuration that is necessary or requested by a customer or end user. In adhering the first substrate to the second substrate, the transversely extending edges of each of the substrates will be substantially aligned with one another.

Next, the intermediate assembly is preferably shaped into a cylindrical configuration at step 160. This may be accomplished by cutting off a length of the formed intermediate assembly and then folding the assembly substantially in half to form the configuration. If the piece is produced in a cut sheet configuration, then no length of material needs to be separated from the web. The longitudinal sides and transversely extending edges of the second substrate will be in alignment with those of the first substrate.

A consumer beverage container is provided at step 162. The beverage container will preferably contain imaging that matches the imaging printed on the business communication piece so as to create a whole, complete or complimentary message. The piece is then slid onto the beverage container and temporarily affixed to the container at step 164. The repositionable adhesive which may be applied at step 152 will temporarily secure the piece to the cup. The process is then complete and can be restarted.

The presently described invention enables conventional print manufacturers, such as producers of business forms and the like, to branch out into other areas such as packaging in order to better diversify their offerings as well as to expose conventional packaging manufacturers to the quality and variability that can be readily provided by such print manufacturers. In addition, by preparing business communications as described in the instant specification, retail establishments can be provided with a more efficient communication vehicle by which to convey a desired message, campaign or activity to an end user or consumer.

It will thus be seen according to the present invention a highly advantageous business communication for use in connection with a consumer beverage package has been provided. While the invention has been described in connection with what is presently considered to be the most practical and preferred embodiment, it will be apparent to those of ordinary skill in the art that the invention is not to be limited to the disclosed embodiment, and that many modifications and equivalent arrangements may be made thereof within the scope of the invention, which scope is to be accorded the broadest interpretation of the appended claims so as to encompass all equivalent structures and products.

The inventors hereby state their intent to rely on the Doctrine of Equivalents to determine and assess the reasonably fair scope of their invention as it pertains to any apparatus, system, method or article not materially departing from but outside the literal scope of the invention as set out in the following claims.

1. A printed business communication piece for holding cylindrical consumer products, comprising;
a first substantially planar substrate having first and second faces, first and second transversely extending edges and first and second longitudinally extending sides, said first face is printed at a resolution of greater than 150 lines per inch;
a second substrate having first and second faces, first and second transversely extending edges and first and second longitudinally extending sides, said second substrate having a regularly undulating pattern and said second substrate first face is at least intermittently bonded to said first substrate second face such that said first and second transversely extending edges of each of said first and second substrates are substantially aligned with one another;
said first and second substrate together form an assembly for use in wrapping a consumer beverage container; and
wherein said second substrate second face is provided with imaging on at least a portion of said undulating pattern.

2. A printed business communication piece as recited in claim 1, wherein said printing on said second substrate second face is selected from a group including promotional, marketing, advertising, seasonal and combinations thereof.

3. A printed business communication piece as recited in claim 1, wherein said second substrate, second face is provided with a pattern of repositionable adhesive to aid in holding said assembly to said consumer beverage container.

4. A printed business communication piece as recited in claim 1, wherein said printing on said second substrate is produced at regularly spaced increments corresponding to sections of upwardly facing undulations.

5. A printed business communication piece as recited in claim 2, wherein said printing on said second substrate second face includes sweepstakes award information.

6. A printed business communication piece as recited in claim 1, including a removable element placed on said first substrate, first face, said removable element containing matching indicia to said printing on said first face.

7. A consumer beverage package, comprising;
a consumer beverage container, said container having imaging provided on an outer surface, said consumer beverage container having a substantially circumferentially extending outer surface;
a first substantially planar substrate having first and second faces, first and second transversely extending edges and first and second longitudinally extending sides, said first face is printed at a resolution of greater than 150 lines per inch and said imaging includes features matching features on said beverage container;
a second substrate having first and second faces, first and second transversely extending edges and first and second longitudinally extending sides, said second substrate having a regularly undulating pattern and said second substrate first face is at least intermittently bonded to said first substrate second face such that said first and second transversely extending edges of each of said first and second substrates are substantially aligned with one another; and
wherein said first and second substrates form a substantially circumferentially extending assembly which conforms to at least a portion of said surface of said consumer beverage container and which said undulating portion is against said outer surface of said consumer beverage container.

8. A consumer beverage package as recited in claim 7, wherein said second substrate second face is provided with imaging on at least a portion of said undulating pattern.

9. A consumer beverage package as recited in claim 7, wherein said printing on said second substrate second face is selected from a group including promotional, marketing, advertising, seasonal and combinations thereof.

10. A consumer beverage package as recited in claim 7, wherein said printing on said second substrate second face is sweepstakes prize information.

11. A method of producing printed business communication pieces for holding cylindrical consumer products substantially in situ, comprising the steps of;
providing a first substantially planar substrate having first and second faces, first and second transversely extending edges and first and second longitudinally extending sides;
printing said first face of said first substrate at a resolution of greater than 150 lines per inch;
advancing a second substrate having first and second faces, first and second transversely extending edges and first and second longitudinally extending sides;
printing on said second face of said second substrate at regularly spaced intervals on said second substrate;
creating a series of regular undulations in said second substrate with each upwardly extending undulation having a printed surface; and
adhering at least intermittently said second substrate first face to said first substrate second face such that said first and second transversely extending edges of each of said first and second substrates are substantially aligned with one another to form an intermediate assembly.

12. A method of producing printed business communication pieces as recited in claim 11, including a further step forming said intermediate assembly into a cylindrical configuration to accommodate a consumer beverage container.

13. A method of producing printed business communication pieces as recited in claim 11, wherein the steps of providing a first substantially planar substrate and advancing said second substrate occurs substantially simultaneously.

14. A method of producing printed business communication pieces as recited in claim 11, wherein the step of printing said second face of said second substrate said printing is provided at a resolution of greater than about 150 lines per inch.

15. A method of producing printed business communication pieces as recited in claim 11, including a further step of providing areas of repositionable adhesive on said second face of said second substrate after the step of adhering said second substrate to said first substrate.

16. A method of producing printed business communication pieces as recited in claim 11, including a further step of tipping on a removable element to a portion of said first face of said first substrate after the step of printing said first face of said first substrate.

17. A method of producing printed business communication pieces as recited in claim 11, providing a consumer beverage package having matching indicia to said printing on at least said first face of said first substrate after the step of adhering said second substrate to said first substrate.

18. A method of producing printed business communication pieces as recited in claim 12, including a further step of temporarily affixing said cylindrical configuration to said consumer beverage container after the step of forming said intermediate assembly into a cylindrical configuration.

19. A method of producing printed business communication pieces as recited in claim 16, wherein said removable element includes printing having matching features to said printing on said first substrate, first face.

20. A method of producing printed business communication pieces as recited in claim 12, an additional step of die cutting said intermediate assembly after the step of adhering said second substrate first face to said first substrate second face.
